(19) United States
(12) Patent Application Publication
(10) Pub. No.: US 2011/0145075 A1
(43) Pub. Date: Jun. 16, 2011

(54) TARGETED CONSUMER ADVERTISING

(75) Inventors: Erno TAURIAINEN, OULU (FI); Ahti VAISANEN, OULU (FI)

(73) Assignee: CASCARD OY, OULU (FI)

(21) Appl. No.: 12/635,757

(22) Filed: Dec. 11, 2009

(51) Int. Cl. G06Q 30/00; G06Q 40/00

(52) U.S. Cl. 705/14.69

(57) ABSTRACT

Implementation of micropayments regarding targeted consumer advertising is disclosed. Fees for consumers for receiving targeted consumer advertisements of targeted consumer advertising are recorded. Consumer-specific micropayment orders are issued, each consumer-specific micropayment order fixing a sum on the basis of the consumer's recorded fees. A commission invoice for the targeted consumer advertising is issued to an advertiser. A consumer fee invoice fixing a sum total of the consumer-specific micropayment orders is issued to the advertiser.

### FIELD

The invention relates generally to targeted consumer advertising, and specifically to an apparatus, a method, a system, and a computer-readable storage medium used to implement micropayments regarding targeted consumer advertising.

### BACKGROUND

Targeted consumer advertising aims at improving the efficiency of the advertising, i.e. an advertisement is ideally delivered only to a consumer interested in the marketed service or product. The motivation to the consumer to receive the targeted advertisement is increased by paying for the consumer a fee for each received advertisement. As such a concept is relatively recent, further sophistication is desirable.

### BRIEF DESCRIPTION

The present invention seeks to provide an improved apparatus, an improved method, an improved system, and an improved computer-readable storage medium.

According to an aspect of the present invention, there is provided an apparatus as specified in claim 1.

According to another aspect of the present invention, there is provided another apparatus as specified in claim 3.

According to another aspect of the present invention, there is provided a method as specified in claim 6.

According to another aspect of the present invention, there is provided a system as specified in claim 10.

According to another aspect of the present invention, there is provided a computer-readable storage medium as specified in claim 11.

### LIST OF DRAWINGS

Embodiments of the present invention are described below, by way of example only, with reference to the accompanying drawings, in which

FIG. 1 illustrates an example configuration of a targeted advertising system;

FIG. 2 illustrates an example structure of an apparatus; and

FIG. 3 illustrates embodiments of a method.

### DESCRIPTION OF EMBODIMENTS

The following embodiments are exemplary. Although the specification may refer to “an” embodiment in several locations, this does not necessarily mean that each such reference is to the same embodiment(s), or that the feature only applies to a single embodiment. Single features of different embodiments may also be combined to provide other embodiments.

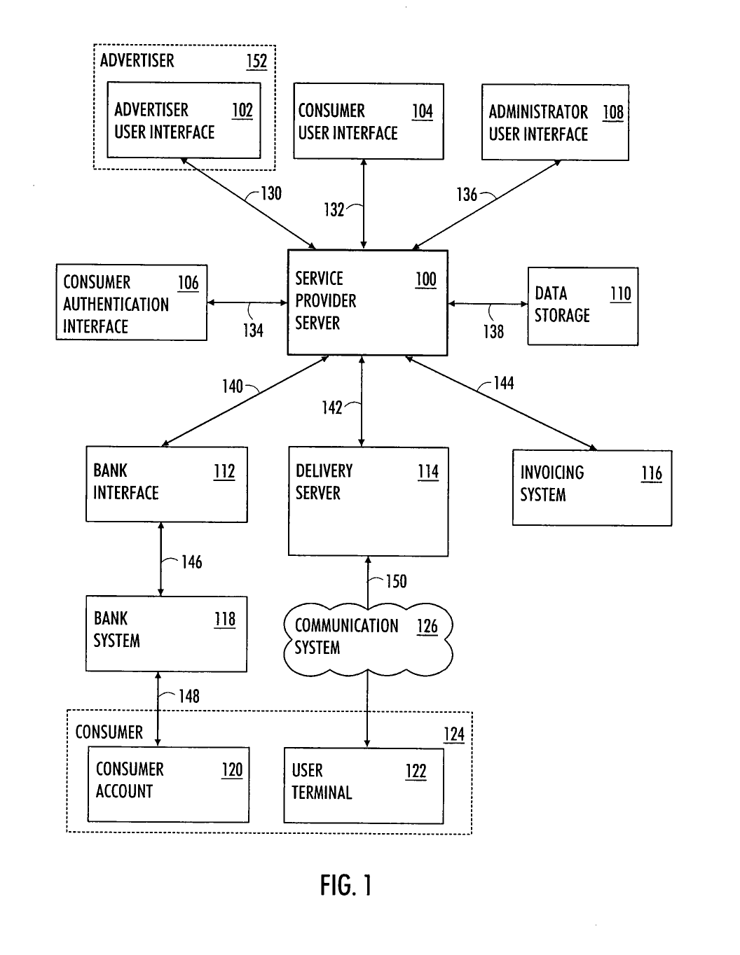

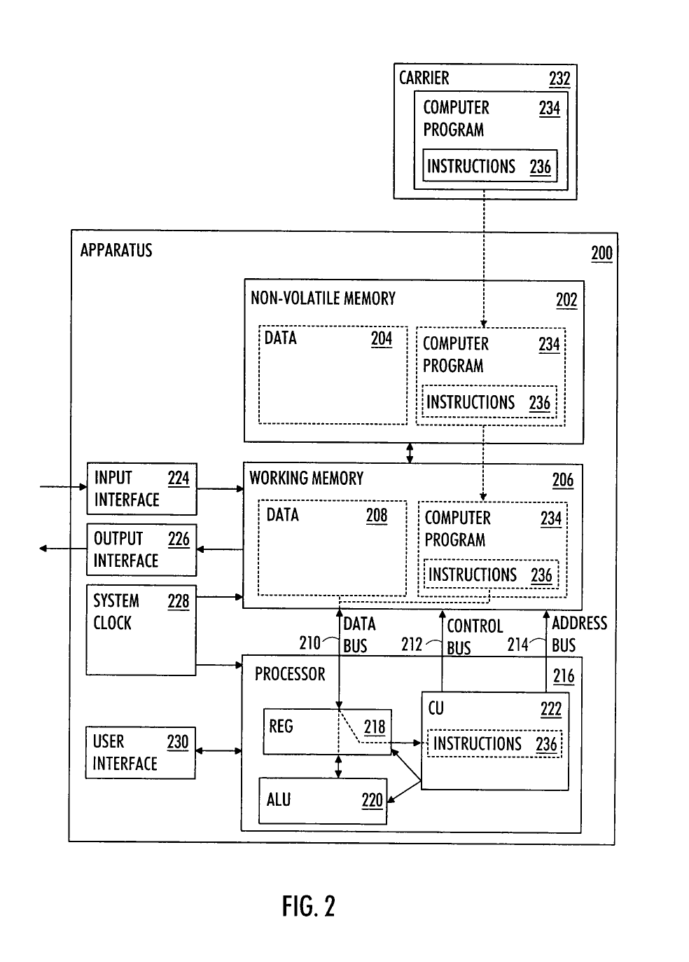

FIGS. 1 and 2 illustrate embodiments of various apparatuses. FIGS. 1 and 2 only show some elements and their implementation may differ from what is shown. The connections shown in FIGS. 1 and 2 are logical connections; the actual physical connections may be different. Interfaces between the various elements may be implemented with suitable interface technologies, such as a message interface, a method interface, a sub-routine call interface, a block interface, or any means enabling communication between functional sub-units. It should be appreciated that the apparatuses may comprise other parts. However, such other parts are irrelevant to the actual invention and, therefore, they need not be discussed in more detail here. It is also to be noted that although some elements are depicted as separate ones, some of them may be integrated into a single physical element. The specifications of the apparatuses may develop rapidly. Such development may require extra changes to an embodiment. Therefore, all words and expressions should be interpreted broadly, and they are intended to illustrate, not to restrict, the embodiments.

With reference to FIG. 1, an example configuration of a targeted advertising system is described. A central element in such a system is a service provider server 100. The service provider server 100 is configured to implement a suitable targeted advertising scheme. Consumers 124 and advertisers 152 are registered in the service provider server 100, whereby information of each consumer 124, each advertiser 152, and each advertisement campaign is stored 138 in data storage 110.

The service provider server 100 is configured to provide various user interfaces. An advertiser user interface 102 is configured to interact 130 with each advertiser 152 in order to produce a suitable targeted advertising campaign: collect basic information from the advertiser, plan the advertising campaign etc. A consumer user interface 104 is configured to recruit 132 consumers 124 to the system by collecting basic information from the consumer, such as age, sex, place of residence, nationality, language(s), hobbies, interests, consumer habits, etc. An administrator user interface 108 is configured to manage 136 the targeted advertising system, i.e. to interact with the advertisers and the customers, plan the campaign in co-operation with the advertiser, implement pricing and reward schemes etc.

A consumer authentication interface 106 is configured to authenticate 134 the consumer, because if each consumer is authenticated, the reliability of the system is improved, i.e. the advertiser is assured that the advertisement is really targeted at true individuals interested in their services or products. An external authentication service may be used to authenticate the consumer 104. Authentication is the act of confirming someone as authentic, i.e. that the claims made by or about the subject are true. The authentication involves confirming the identity of the person. The external authentication service may be a registry maintained by a government authority, population register centre, a service maintained by a bank, or any other authentication service capable of reliably checking the identity of the consumer 104.

A delivery server 114 is configured to deliver 150 the targeted advertisement to each consumer 124 on the basis of information 142 received from the service provider server 100. The delivery server 114 is configured to deliver 150 the targeted advertisement to the consumer 124 through a communication system 126. The delivery server 114 may be an outgoing mobile message server, or an outgoing email server, for example. The communication system 126 may communicate in a wired or a wireless fashion. Such communication techniques utilize electric and/or magnetic radiation. GSM (Global System for Mobile Communications), WCDMA (Wideband Code Division Multiple Access), WLAN (Wireless Local Area Network) or Bluetooth® are examples of wireless communication standards, but also other standard communication techniques and even non-standard and/or proprietary wireless communication techniques may be used. Naturally, all standard/non-standard wired communication techniques may be used, such as Ethernet, TCP/IP, etc. The communication network may be the Internet, or a part of the Internet, or it may be coupled to the Internet. The protocols used and the specifications of the communication techniques, especially in wireless communication, develop rapidly. Such development may require extra changes to an embodiment. Therefore, all words and expressions should be interpreted broadly and they are intended to illustrate, not to restrict, the embodiment.

The consumer 124 may use a user terminal 122 configured to receive 150 the targeted advertisement from the delivery server 114 through the communication system 126. The targeted advertisement may be received as an SMS (Short Message Service) message, an MMS (Multimedia Message Service), through some other instant messaging format, an electronic mail message, a Twitter tweet, or on a personal page in the web or in some social media, etc. In all cases, the user terminal 122 may be used to view the targeted advertisement. The user terminal 122 may be a mobile device, which refers to a portable computing device or a computer, such as a desktop computer, a laptop computer, a palmtop computer, a terminal of a computer system, or any other suitable electronic user terminal capable of presenting the targeted advertisement. The mobile device may be a wireless mobile communication device operating with or without a subscriber identification module (SIM), including, but not limited to, the following types of devices: mobile phone, smartphone, personal digital assistant (PDA), handset.

In summary, the consumer 124 indicates interest areas, whereupon the advertiser 152 may provide targeted advertisement to the consumer. The advertiser 152 credits the consumer with a small sum of money for receiving the advertisement, i.e. the advertiser 152 makes a micropayment to the consumer. An invoicing system 116 is configured to receive 144 invoice information from the service provider server 100 and to provide the needed invoices on the basis of the received information. A ‘micropayment’ refers to a means for transferring very small amounts of money in situations where collecting such small amounts of money with the usual payment systems is impractical or very expensive in terms of the amount of money being collected. The money sum may be a few Eurocents or even less.

Unique in the system is how the overall payment invoiced from the advertiser 152 is processed as two separate streams, the part going to the consumers 124 being then split into micropayments to be paid to each individual consumer 124. When the consumer 124 receives or reads the advertisement, it is recorded in the data storage 110 and tagged how much the consumer will be credited for the transaction. When the advertiser 152 wants to send the advertisement for instance to one thousand consumers 124, each consumer 124 receiving the advertisement will be recorded individually for their credit. The advertiser 152 is then invoiced through the invoicing system 116 for two advertising campaign payments: a commission for the service provider, and a combined consumer fee. The computer system splits the lump sum going to consumers who have received the advertisement (=the combined consumer fee) further to micropayments for the consumers according to the records in the data storage 110. These micropayments are then transferred 140 over a bank interface 112 to 146 a bank system 118 to be credited 148 to an account such as a consumer account 120. The whole transaction history is recorded and each individual user will see his/her transaction history as a report in the computer system. The information and money flow is as follows (not in a definite temporal order): 1) the consumer reads the advertisement in the web or receives an email or SMS; 2) reception of the advertisement is recorded into the database; 3) the respective credit (micropayment) is recorded into the consumer's account in the computer system; 4) the computer system then either moves instantaneously the credit into the consumer's virtual account or cumulates it as a bigger sum and makes the transaction of the cumulated sum later; and 5) the advertiser 152 pays the cumulated sum of the consumers, and a commission fee for the service provider. It is to be noted that the consumer fee invoice and the commission invoice are both paid by the advertiser 152 directly, or a financing house may first pay these expenses which are then later invoiced from the actual advertiser 152.

The targeted advertising system described in FIG. 1 may be implemented by one or more apparatuses. With reference to FIG. 2, an example structure of an apparatus 200 is described.

The apparatus 200 comprises a processor 216, and a memory 202/206 including computer program 234 instructions 236. The memory 202/206 and the computer program 234 instructions 236 are configured to, with the processor 216, cause the apparatus 200 to perform: record fees for consumers 124 for receiving targeted consumer advertisements of targeted consumer advertising; issue consumer-specific micropayment orders, each consumer-specific micropayment order fixing a sum on the basis of the consumer's recorded fees; issue a commission invoice for the targeted consumer advertising to an advertiser 152; and issue a consumer fee invoice fixing a sum total of the consumer-specific micropayment orders to the advertiser 152. In summary, there are two separate invoices:
the commission invoice, which is for the targeted advertising service provided by the service provider and which the advertiser 152 pays to the service provider; and
the consumer fee invoice, which is for the reception of the targeted advertisement by the consumers 124, this invoice being issued by the service provider on behalf of the customers 124, and, consequently, it is paid by the advertiser 152 to the consumers 124.

The consumer-specific micropayment order is not an invoice but an instruction on how the sum given in the consumer fee invoice and paid by the advertiser 152 is divided among the consumers 124. The advertiser 152 is not informed of the actual identities of the consumers 124, but only summary information is given in the consumer fee invoice. Such summary information may state, for example: “Targeted advertising was realized by the following customer interaction events: 5000 SMS messages, 4500 emails, and 3700 web clicks”. As information on an individual consumer 124 is not disclosed to the advertiser 152, the consumer 124 is willing to give detailed personal information and information on her consumer habits to the service provider.

Another advantage of the described invoicing mechanism is that the cash flow relating to the consumer fee invoice and the consumer-specific micropayment orders does not go through the service provider, but it is rather handled as numerous separate flows between the advertiser 152 and each consumer 124. Naturally, since the number of advertisers 152 is, in principle, unlimited, there may exist numerous advertiser-consumer pairs. There may be national limits for the amount of fees that the consumer 124 may receive from one advertiser 152 tax-free. In this respect, it is advantageous that the money does not come from one service provider servicing numerous advertisers 152, but the money flow comes separately from each individual advertiser 152 to the consumer 124.

In an embodiment, the apparatus 200 further comprises a data output interface 226 configured to transmit the consumer-specific micropayment orders to a bank computer.

The apparatus 200 functionality described so far may be implemented within the service provider server 100, and/or within the invoicing system 116 described in FIG. 1. This part of the system may be called ‘a first apparatus’.

A second apparatus 200 may also comprise the processor 216, and the memory 202/206 including the computer 234 program instructions 236. The memory 202/206 and the computer program 234 instructions 236 are configured to, with the processor 216, cause the apparatus 200 to perform: process consumer-specific micropayment orders, each consumer-specific micropayment order fixing a sum as a fee for a targeted advertisement for a consumer 124; credit an account with the sum fixed in the consumer-specific micropayment order of the consumer 124; and process a consumer fee invoice fixing a sum total of the consumer-specific micropayment orders and a payment order from the advertiser 152 for the consumer fee invoice. The sum total of the consumer fee invoice paid by the advertiser 152 may be transferred to one common account, each consumer 124 having a virtual account within the common account and the balance of the virtual account being maintained for each consumer 124 separately: the consumer-specific micropayment order increases the balance of the virtual account with the fees earned by the customer 124 for receiving the targeted advertisements. Such an arrangement with one common account and its numerous virtual consumer-specific accounts may provide savings in bank transfer fees. Another option is that each consumer-specific account is a separate, real account of only one consumer 124.

In an embodiment, the apparatus 200 further comprises a data input interface 224 configured to receive the consumer-specific micropayment orders from the service provider and the payment order for the consumer fee invoice from the advertiser 152.

In another embodiment, the memory 202/206 and the computer program 234 instructions 236 are further configured to, with the processor 216, cause the apparatus 200 to perform: process the commission invoice fixing a sum for the service provider and a payment order from the advertiser 152 for the commission invoice.

In a further embodiment, the account is one of a personal prepaid card, a personal debit card, a personal credit card, a bank account of the consumer, a third party account. The third party account may be a bank account of some charity organization such as Red Cross. Banque Invik S.A. based in Luxembourg offers a prepaid card, EveryWhereMoney™ account, which may be used in the described targeted advertising system. With EveryWhereMoney™ the consumer receives a prepaid account in a currency of her choice with a payment card attached. The payment card is worldwide accepted and may be used to withdraw money and to purchase with merchants or securely in the Internet. As the advertiser pays the consumer-specific micropayment invoice by bank transfer, the sum fixed in the micropayment invoice is transferred to the EveryWhereMoney™ account of the consumer.

The ‘second apparatus’ 200 functionality thus described may be implemented within the bank system 118 described in FIG. 1.

In general, the apparatus 200 may be an electronic digital computer, which may comprise, besides the processor 216 and the working memory 206, a system clock 228. Furthermore, the computer 200 may comprise a number of peripheral devices. In FIG. 2, some peripheral devices are illustrated: the non-volatile memory 202, the input interface 224, the output interface 226, and a user interface 230 (such as a pointing device, a keyboard, a display, etc.). The user interface 230 may be used for user interaction; to implement the user interfaces 102, 104, 106 and 108 of FIG. 1, for example. Naturally, the computer 200 may comprise a number of other peripheral devices not illustrated here for the sake of clarity.

The system clock 228 constantly generates a stream of electrical pulses, which cause the various transferring operations within the computer 200 to take place in an orderly manner and with specific timing.

Depending on the processing power needed, the computer 200 may comprise several (parallel) processors 216, or the required processing may be distributed amongst a number of computers 200. The computer 200 may be a laptop computer, a personal computer, a server computer, a mainframe computer, or any other suitable computer. As the processing power of portable communications terminals, such as mobile phones, is constantly increasing, the apparatus 200 functionality may be implemented into them as well. Besides the contemporary computers utilizing binary digits, or bits, for presenting data 208 and instructions 236 by the use of the Binary number system's two-binary digits “0” and “1”, the emerging quantum computers may also be used, such quantum computers utilizing quantum bits, or qubits, instead of bits.

The term ‘processor’ refers to a device that is capable of processing data. The processor 216 may comprise an electronic circuit or electronic circuits implementing the required functionality, and/or a microprocessor or microprocessors running computer program 234 instructions 236 implementing the required functionality. When designing the implementation, a person skilled in the art will consider the requirements set for the size and power consumption of the apparatus, the necessary processing capacity, production costs, and production volumes, for example. The electronic circuit may comprise logic components, standard integrated circuits, application-specific integrated circuits (ASIC), and/or other suitable electronic structures.

The microprocessor 216 implements functions of a central processing unit (CPU) on an integrated circuit. The CPU 216 is a logic machine executing computer program 234 instructions 236. The program instructions 236 may be coded as a computer program 234 using a programming language, which may be a high-level programming language, such as C, or Java, or a low-level programming language, such as a machine language, or an assembler. The CPU 216 may comprise a set of registers 218, an arithmetic logic unit (ALU) 220, and a control unit (CU) 222. The control unit 222 is controlled by a sequence of program instructions 236 transferred to the CPU 216 from the working memory 206. The control unit 222 may contain a number of microinstructions for basic operations. The implementation of the microinstructions may vary depending on the CPU 216 design. The microprocessor 216 may also have an operating system (a general purpose operating system, a dedicated operating system of an embedded system, or a real-time operating system, for example), which may provide the computer program 234 with system services.

There may be three different types of buses between the working memory 206 and the processor 216: a data bus 210, a control bus 212, and an address bus 214. The control unit 222 uses the control bus 212 to set the working memory 206 in two states, one for writing data into the working memory 206 and the other for reading data from the working memory 206. The control unit 222 uses the address bus 214 to send to the working memory 206 address signals for addressing specified portions of the memory in writing and reading states. The data bus 210 is used to transfer data 208 from the working memory 206 to the processor 216 and from the processor 216 to the working memory 206, and to transfer the instructions 236 from the working memory 206 to the processor 216.

The working memory 206 may be implemented as a random-access memory (RAM), where the information is lost after the power is switched off. The RAM is capable of returning any piece of data in a constant time, regardless of its physical location and whether or not it relates to a previous piece of data. The data may comprise data 208 relating to targeted advertising and its invoicing, any temporary data needed during the processing, and computer 234 program instructions 236 etc.

The non-volatile memory 202 retains the stored information even when not powered. Examples of non-volatile memory include read-only memory (ROM), flash memory, magnetic computer storage devices, such as hard disk drives, and optical discs. As is shown in FIG. 1, the non-volatile memory 110 may store both data 204 relating to targeted advertising and its invoicing and computer program 234 instructions 236.

An embodiment provides a computer-readable storage medium comprising computer 234 program instructions 236 which, when loaded into the apparatus 200, cause the apparatus 200 to perform: record fees for consumers for receiving targeted consumer advertisements of targeted consumer advertising; issue consumer-specific micropayment orders, each consumer-specific micropayment order fixing a sum on the basis of the consumer's recorded fees; issue a commission invoice for the targeted consumer advertising to an advertiser; and issue a consumer fee invoice fixing a sum total of the consumer-specific micropayment orders to the advertiser.

The computer program 234 may be in a source code form, object code form, or in some intermediate form. The computer program 234 may be stored in a carrier 232, which may be any entity or device capable of carrying the program to the apparatus 200. The carrier 232 may be implemented for example as follows: the computer program 234 may be embodied, besides a computer-readable storage medium, on a record medium, stored in a computer memory, embodied in a read-only memory, carried on an electrical carrier signal, carried on a telecommunications signal, and/or embodied on a software distribution medium. In some jurisdictions, depending on the legislation and the patent practice, the carrier 232 may not be a telecommunications signal.

FIG. 2 illustrates that the carrier 232 may be coupled to the apparatus 200, whereupon the program 234 comprising the program instructions 236 is transferred into the non-volatile memory 202 of the apparatus 200. The program 234 with its program instructions 236 may be loaded from the non-volatile memory 202 into the working memory 206. During running of the program 234, the program instructions 236 are transferred via the data bus 210 from the working memory 206 into the control unit 222, wherein usually a portion of the instructions 236 resides and controls the operation of the apparatus 200.

There are many ways to structure the program 234. The operations of the program may be divided into functional modules, sub-routines, methods, classes, objects, applets, macros, etc., depending on the software design methodology and the programming language used. In modern programming environments, there are software libraries, i.e. compilations of ready made functions, which the program may utilize for performing a wide variety of standard operations.

Besides the basic entities described earlier, there may be a number of other, supplementary entities. Data 208, which comprises data relating to targeted advertising and its invoicing, may be brought into the working memory 206 via the non-volatile memory 202 or via the input interface 224. There may exist a further software entity for this operation. The data 204 may have been brought into the non-volatile memory 202 via a memory device (such as a memory card, an optical disk, or any other suitable non-volatile memory device) or via a telecommunications connection (via Internet, or another wired/wireless connection). The input interface 224 may be a suitable communication bus, such as USB (Universal Serial Bus) or some other serial/parallel bus, operating in a wireless/wired fashion. The input interface 224 may be directly coupled to an electronic system, or there may be a telecommunications connection between the input interface 224 and the electronic system.

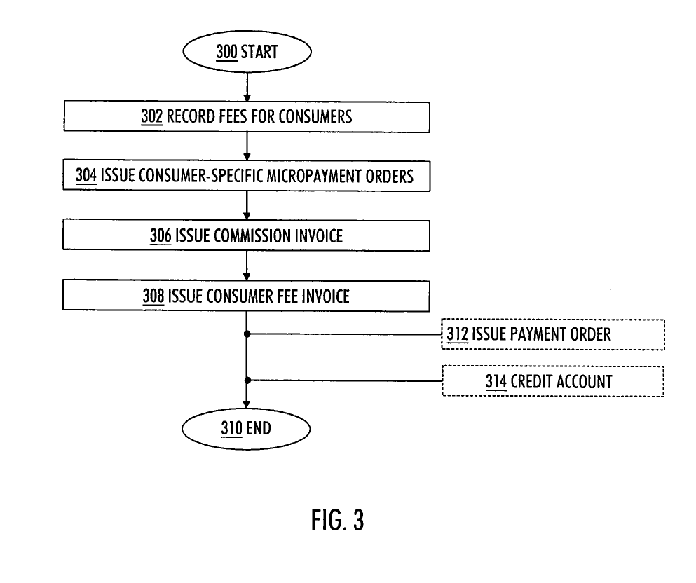

Next, a method will be described with reference to FIG. 3. The operations are in no absolute chronological order, and some of the operations may be performed simultaneously or in an order differing from the given one. Other functions, not described in this application, may also be executed between the operations or within the operations. Some of the operations or parts of the operations may also be left out or replaced by a corresponding operation or part of the operation. The method starts in 300. In 302, an electronic apparatus records fees for consumers for receiving targeted consumer advertisements of targeted consumer advertising. In 304, an electronic apparatus issues consumer-specific micropayment orders, each consumer-specific micropayment order fixing a sum on the basis of the consumer's recorded fees. In 306, electronic apparatus issues a commission invoice for the targeted consumer advertising to an advertiser. In 308, an electronic apparatus issues a consumer fee invoice fixing a sum total of the consumer-specific micropayment orders to the advertiser. The method ends in 310. The embodiments of earlier described apparatuses may also be used to enhance the method. In an embodiment, a computer-readable storage medium comprising program instructions which, when loaded into an apparatus, cause the apparatus to perform the described operations. ‘An electronic apparatus’ may be a single apparatus, or the processing may be distributed among a number of electronic apparatuses, depending on the implementation and the required processing capacity.

Next, some embodiments of the method will be described. These embodiments may be freely combined with each other in order to produce further embodiments.

In an embodiment, the method further comprises: issuing 312, by an electronic apparatus, a payment order for the consumer fee invoice from the advertiser.

In another embodiment, the method further comprises: crediting 314, by an electronic apparatus, an account with a sum fixed in the consumer-specific micropayment order. The account may be one of a personal prepaid card, a personal debit card, a personal credit card, a bank account of the consumer, a third party account, for example.

It will be obvious to a person skilled in the art that, as technology advances, the inventive concept can be implemented in various ways. The invention and its embodiments are not limited to the examples described above but may vary within the scope of the claims.

What is claimed is:

1. An apparatus comprising
a processor; and
a memory including computer program instructions,
the memory and the computer program instructions being configured to, with the processor, cause the apparatus to:
record fees for consumers for receiving targeted consumer advertisements of targeted consumer advertising,
issue consumer-specific micropayment orders, each consumer-specific micropayment order fixing a sum on the basis of the consumer's recorded fees,
issue a commission invoice for the targeted consumer advertising to an advertiser, and
issue a consumer fee invoice fixing a sum total of the consumer-specific micropayment orders to the advertiser.

2. The apparatus of claim 1, further comprising a data output interface configured to transmit the consumer-specific micropayment orders to a bank computer.

3. An apparatus comprising
a processor; and
a memory including computer program instructions, the memory and the computer program instructions being configured to, with the processor, cause the apparatus to:
process consumer-specific micropayment orders, each consumer-specific micropayment order fixing a sum as a fee for a targeted advertisement for a consumer,
credit an account with a sum fixed in the consumer-specific micropayment order, and
process a consumer fee invoice fixing a sum total of the consumer-specific micropayment orders and a payment order from the advertiser for the consumer fee invoice.

4. The apparatus of claim 3, further comprising a data input interface configured to receive the consumer-specific micropayment orders from a service provider and the payment order for the consumer fee invoice from the advertiser.

5. The apparatus of claim 3, wherein the account is one of a personal prepaid card, a personal debit card, a personal credit card, a bank account of the consumer, a third party account.

6. A method comprising:
recording by an electronic apparatus fees for consumers for receiving targeted consumer advertisements of targeted consumer advertising;
issuing by an electronic apparatus consumer-specific micropayment orders, each consumer-specific micropayment order fixing a sum on the basis of the consumer's recorded fees;
issuing by an electronic apparatus a commission invoice for the targeted consumer advertising to an advertiser; and
issuing by an electronic apparatus a consumer fee invoice fixing a sum total of the consumer-specific micropayment orders to the advertiser.

7. The method of claim 6, further comprising:
issuing by an electronic apparatus a payment order for the consumer fee invoice from the advertiser.

8. The method of claim 6, further comprising:
crediting by an electronic apparatus an account with a sum fixed in the consumer-specific micropayment order.

9. The method of claim 6, wherein the account is one of a personal prepaid card, a personal debit card, a personal credit card, a bank account of the consumer, a third party account.

10. A system comprising:
a first apparatus comprising a first processor, a first memory including computer program instructions, the first memory and the first computer program instructions being configured to, with the first processor, cause the first apparatus to:
record fees for consumers for receiving targeted consumer advertisements of targeted consumer advertising,
issue consumer-specific micropayment orders, each consumer-specific micropayment order fixing a sum on the basis of the consumer's recorded fees,
issue a commission invoice for the targeted consumer advertising to an advertiser, and
issue a consumer fee invoice fixing a sum total of the consumer-specific micropayment orders to the advertiser; and
a second apparatus comprising a second processor, a second memory including second computer program instructions, the second memory and the second computer program instructions being configured to, with the second processor, cause the second apparatus to:
process the consumer-specific micropayment orders,
credit an account with the sum fixed in the consumer-specific micropayment order of the consumer, and
process the consumer fee invoice and a payment order from the advertiser for the consumer fee invoice.

11. A computer-readable storage medium comprising computer program instructions which, when loaded into an apparatus, cause the apparatus to:
record fees for consumers for receiving targeted consumer advertisements of targeted consumer advertising;
issue consumer-specific micropayment orders, each consumer-specific micropayment order fixing a sum on the basis of the consumer's recorded fees;
issue a commission invoice for the targeted consumer advertising to an advertiser; and
issue a consumer fee invoice fixing a sum total of the consumer-specific micropayment orders to the advertiser.
